(19) United States
(12) Patent Application Publication
(10) Pub. No.: US 2013/0285790 A1
(43) Pub. Date: Oct. 31, 2013

(54) MOTION SENSING DEVICE FOR PORTABLE ELECTRONIC DEVICE

(71) Applicants: TEN-CHEN HO, Tu-Cheng, New Taipei (TW); XIAO-LIAN HE, Shenzhen City, Guangdong Province (CN)

(72) Inventors: TEN-CHEN HO, Tu-Cheng, New Taipei (TW); XIAO-LIAN HE, Shenzhen City, Guangdong Province (CN)

(73) Assignees: HON HAI PRECISION INDUSTRY CO., LTD., Tu-Cheng (TW); HONG FU JIN PRECISION INDUSTRY (ShenZhen) CO., LTD., Shenzhen City (CN)

(21) Appl. No.: 13/563,849

(22) Filed: Aug. 1, 2012

(30) Foreign Application Priority Data
Apr. 26, 2012 (CN) 201210125616.2

(51) Int. Cl. G01P 15/02; G08B 21/00

(52) U.S. Cl. 340/1.1; 73/514.38

(57) ABSTRACT

A motion sensing device includes a sensing chamber including at least one group of sensing surfaces, a signal generator, a sensing body and at least one elastic assembly corresponding to each group of the sensing surfaces. Each group of sensing surfaces includes two opposite sensing surfaces. The signal generator is electrically connected to the sensing surfaces and transmits different control signals to each sensing surface. Each elastic assembly includes two elastic members. One end of each elastic member secured to the sensing surfaces, and another end of each elastic member secured to the sensing body. The motion sensing device is shaken, the sensing body contacts with the corresponding sensing surface and transmits the control signal.

### BACKGROUND

1. Technical Field

The disclosure generally relates to motion sensing devices, and particularly to a motion sensing device for a portable electronic device having a screen shaking function.

2. Description of Related Art

To change the wallpaper or switch a song of a mobile phone, the user usually need to operate a corresponding switch key. This conventional operation is inflexible. A screen shaking function realized by motion sensing technology gradually replaces the conventional operation as a new function. The portable electronic device can be shaken to activate a corresponding command such as changing the wallpaper or switching the song.

A typical mobile phone having the screen shaking function usually includes a sensing system. The sensing system includes a G-sensor or an acceleration sensor and related circuits to support and realize the screen shaken function. However, the sensing system is complex in structure and increases the cost of the mobile phone.

Therefore, there is room for improvement within the art.

### BRIEF DESCRIPTION OF THE DRAWING

Many aspects of the present disclosure can be better understood with reference to the following drawing. The components in the drawing are not necessarily drawn to scale, the emphasis instead being placed upon clearly illustrating the principles of the disclosure.

FIG. 1 is a schematic view of a portable electronic device having a screen shaking function, according to an exemplary embodiment of the disclosure.

FIG. 2 is a schematic view of a motion sensing device, according to an exemplary embodiment of the disclosure.

### DETAILED DESCRIPTION

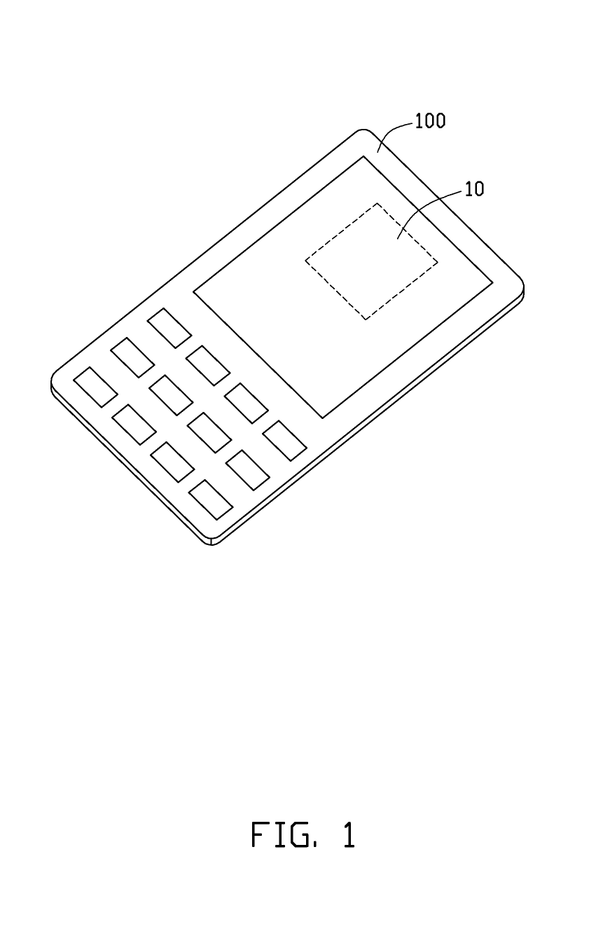

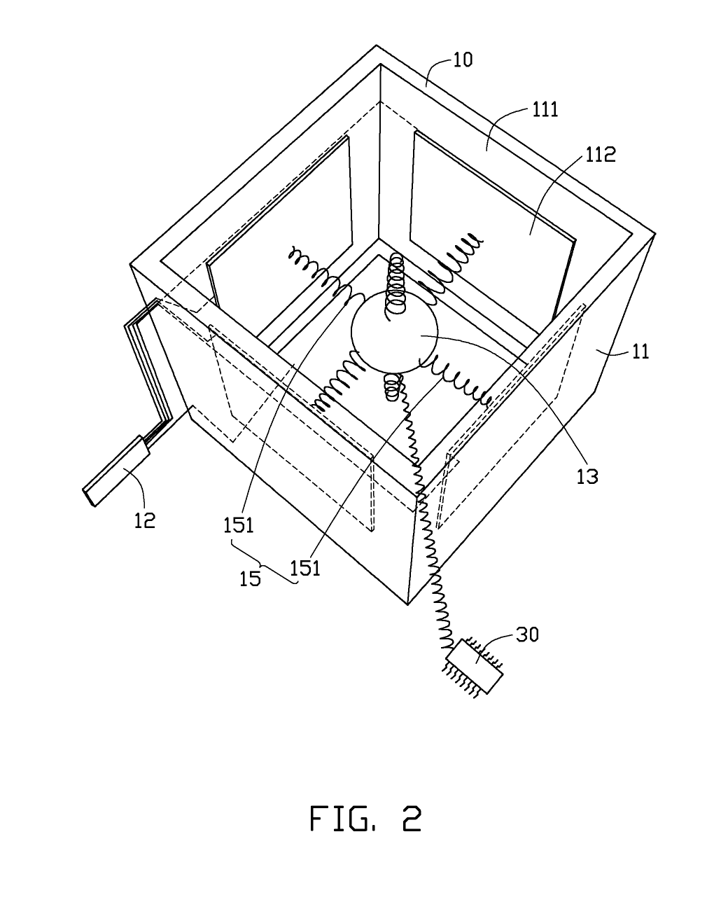

Referring to FIG. 1 the portable electronic device 100 includes a motion sensing device 10 and a processor 30 (shown in FIG. 2) electrically connected to the sensing device 10. The sensing device 10 senses shaking motions of the portable electronic device 100 along left, right, front, rear, up, and down directions of three perpendicular axes, and transmits corresponding control signals to the processor 30. The processor 30 executes corresponding commands according to the control signals to realize a screen shaking function of the portable electronic device 100.

Referring to FIG. 2, the sensing device 10 includes a sensing chamber 11, a signal generator 12, a sensing body 13, and a plurality of elastic assembly 15.

The sensing chamber 11 is a hollow cube including six inner walls 111 (one of the inner walls is omitted in FIG. 2, for clarity). Each inner wall 111 includes a conductive sensing surface 112 positioned at a middle portion of the inner wall 111. In one exemplary embodiment, the sensing surface 112 is substantially square. The six inner walls 111 are divided into three groups. Each group of the inner walls 111 includes two parallel and opposite inner walls 111. The three groups of the inner walls 111 respectively correspond to the left and right directions, front and rear directions, and up and down directions of the portable electronic device 100.

The signal generator 12 is electrically connected to the six sensing surfaces 112 and transmits the different control signals to each sensing surface 112, respectively. The signal generator 12 may be a power supply and provides different voltages as the control signals to each sensing surface 112.

The sensing body 13 is made of conductive material. In the exemplary embodiment, the sensing body 12 is substantially spherical. The sensing body 13 is positioned at a center of the sensing chamber 11 corresponding to each center of the sensing surface 112. The sensing body 13 is electrically connected to the processor 30.

The elastic assemblies 15 are made of insulating material. The number of the elastic assemblies 15 is corresponding to that of groups of the sensing surfaces 112, in the exemplary embodiment, there are three group of elastic assemblies 15 corresponding to the sensing surface 112 positioned at the left and light directions, the front and rear directions, and the up and down directions.

Each elastic assembly 15 includes two elastic members 151. Each elastic member 151 is a spring. One end of each elastic member 151 is secured to the center of the sensing surface 112. Another end of each elastic member 151 is secured to a surface of the sensing body 13. The sensing body 13 is suspended at the center of the sensing chamber 11 by the elastic members 151. Every two elastic member 151 belonging to the same elastic assembly 15 are secured to the centers of the two sensing surfaces 112 of one same group. Thus, the two elastic members 151 belonging to the same elastic assembly 15 are collinear.

When the portable electronic device 100 is shaken toward the left direction, the elastic members 151 secured to the sensing surfaces 112 corresponding to the left and right directions of portable electronic device 100 are deformed. The sensing body 13 contacts with the sensing surface 112 corresponding to the left direction and electrically connected to the processor 30. The corresponding control signal can be transmitted to the processor 30. Accordingly, when the portable electronic device 100 is shaken toward other directions, the sensing body 13 contacts with the corresponding sensing surface 112 and transmits the corresponding control signals to the processor 30. The processor 30 executes corresponding commands according to the control signals. Thus, the portable electronic device 100 can realize a screen shaking function along the left and right directions, the front and rear directions, and the up and down directions of three perpendicular axes.

In other exemplary embodiment, if the portable electronic device 100 only needs to realize a screen shaking function along two or one axes, the number of the groups of sensing surface 112 and the elastic member 15 can be correspondingly reduced.

The portable electronic device 100 using the motion sensing device 10 replacing a conventional sensor system to realize the screen shaking function has a simple structure and a relative lower cost.

It is believed that the exemplary embodiments and their advantages will be understood from the foregoing description, and it will be apparent that various changes may be made thereto without departing from the spirit and scope of the disclosure or sacrificing all of its material advantages, the examples hereinbefore described merely being preferred or exemplary embodiments of the disclosure.

1. A motion sensing device, comprising:
a sensing chamber, the sensing chamber comprising at least one group of sensing surfaces, each group of sensing surfaces comprising two opposite sensing surfaces;
a signal generator electrically connected to the sensing surfaces and transmitting a control signal to each sensing surface, and the control signals transmitted to the sensing surfaces are different;
a sensing body suspended in the sensing chamber; and
at least one elastic assembly corresponding to each group of the sensing surfaces, each elastic assembly comprising two elastic members, one end of each elastic member secured to one of the sensing surfaces, and another end of each elastic member secured to the sensing body; wherein when the motion sensing device is shaken, the sensing body contacts with the corresponding sensing surface and is electronically connected to the corresponding sensing surface to obtain the control signal from the corresponding sensing surface.

2. The motion sensing device of claim 1, wherein the sensing chamber is a hollow cube, and comprises three groups of sensing surfaces electrically connected to the signal generator to receive the control signals corresponding to shake of the motion sensing device along three perpendicular axes.

3. The motion sensing device of claim 2, wherein the sensing body is ball suspended at a center of the sensing chamber.

4. The motion sensing device of claim 1, wherein the sensing chamber is a hollow cube, and comprises two groups of sensing surfaces electrically connected to the signal generator to receive the control signals corresponding to shake of the motion sensing device along two perpendicular axes.

5. The motion sensing device of claim 1, wherein the signal generator is a power supply providing preset voltages to the sensing surfaces.

6. A portable electronic device, comprising:
a motion sensing device, comprising:
a sensing chamber, the sensing chamber comprising at least one group of sensing surfaces, each group of sensing surface comprising two opposite sensing surfaces;
a signal generator electrically connected to the sensing surfaces and transmitting a control signal to each sensing surface, and the control signals transmitted to the sensing surfaces are different;
a sensing body suspended in the sensing chamber; and
at least one elastic assembly corresponding to each group of the sensing surfaces, each elastic assembly comprising two elastic members, one end of each elastic member secured to one of the sensing surfaces, and another end of each elastic member secured to the sensing body; wherein when the motion sensing device is shaken, the sensing body contacts with the corresponding sensing surface and is electronically connected to the corresponding sensing surface to obtain the control signal from the corresponding sensing surface;
a processor electrically connected to the motion sensing device, the processor receiving the control signal from the sensing body, and executing a corresponding command according to the control signal.

7. The portable electronic device of claim 6, wherein the sensing chamber is a hollow cube, and comprises three groups of sensing surfaces electrically connected to the signal generator to receive the control signals corresponding to shake of the motion sensing device along three perpendicular axes.

8. The portable electronic device of claim 7, wherein the sensing body is a sphere suspended at a center of the sensing chamber.

9. The portable electronic device of claim 6, wherein the sensing chamber is a hollow cube, and comprises two groups of sensing surfaces electrically connected to the signal generator to receive the control signals corresponding to shake of the motion sensing device along two perpendicular axes.

10. The portable electronic device of claim 6, wherein the signal generator is a power supply providing preset voltages to the sensing surfaces.
